(19) United States
(12) Patent Application Publication
(10) Pub. No.: US 2006/0282300 A1
(43) Pub. Date: Dec. 14, 2006

(54) System for influencing and monitoring the movement of products

(75) Inventor: Rajiv Bobby Dave, Salisbury (GB)

Correspondence Address: WOLF GREENFIELD & SACKS, PC, FEDERAL RESERVE PLAZA, 600 ATLANTIC AVENUE, BOSTON, MA, 02210-2206, US

(73) Assignee: GW Pharma Limited, Salisbury (GB)

(21) Appl. No.: 11/442,034

(22) Filed: May 26, 2006

Related U.S. Application Data
(60) Provisional application No. 60/685,046, filed on May 26, 2005.

(51) Int. Cl. G05B 19/418

(52) U.S. Cl. 705/8

(57) ABSTRACT

The present invention relates to a system for influencing and monitoring the movement of products between points along a pathway. The invention enables monitoring of products throughout the entire supply chain from, for example, the site of manufacture to the end-user, for example, the patient. At least one point-product interface may enable the influence of the products movement at each step of the pathway.

### FIELD OF THE INVENTION

The present invention relates to a system for influencing and monitoring the movement of products between points along a pathway. The invention enables monitoring of products throughout the entire supply chain from, for example, the site of manufacture to the end-user, for example, the patient. At least one point-product interface may enable the influence of the products movement at each step of the pathway.

### BACKGROUND TO THE INVENTION

In recent years there has been a vast increase in the development of systems that enable doctors to collect data and interact with their patients. Such systems are useful as they provide doctors or other health care providers with accurate information concerning the use and compliance of the medication that they have prescribed.

U.S. Pat. No. 5,390,238 (Motorola Inc.) describes a home health and communications support system whereby a unit monitors a patient. The unit comprises a medication controller and a communications module to enable the patient to interact with the unit. The system is targeted to improve compliance particularly in elderly patients. Although the system is able to store and manipulate data it is unable to provide a physical lock-out mechanism should it detect that the system is being misused or that a patient has not been authorised to use the drug.

U.S. Pat. No. 5,897,493 (Health Hero Network Inc.) describes a system for monitoring patients remotely. Such a system enables a doctor or health care provider to ask a patient questions relating to their health or medication. The information collected is stored and transmitted and allows monitoring of the patient. Unfortunately the system does not enable a doctor or health care provider to alter or stop a patient's medication remotely in real-time.

U.S. Pat No. 5,960,403 (Health Hero Network Inc.) describes a system and method for remotely monitoring a patient. It also provides the ability to train a patient to allow them to comply with their prescribed treatment plan. The data that is collected is transmitted to a doctor or health care providers computer to be analysed, therefore allowing him to monitor the patient's status and compliance. Such a system and method is however unable to alter or control a patient's usage of their medication.

U.S. Pat. No. 6,161,095 (Health Hero Network Inc.) describes a system and method whereby a community of individuals are able to interact to obtain information relating to compliance with a treatment regimen. Data is collected by a set of client devices which when coupled with a portable device can send the information to different individuals. The system is able to update a patient's regimen but unfortunately not in real-time.

WO 2001/88828 (Alaris Medical Systems Inc.) describes a medication management and drug delivery system. The system is able to communicate and validate patient information to avoid medication errors. Although the system and method provides means to control and monitor a patient's medication it is unable to securely authenticate a user of a specific medication at a specific stage in the supply chain.

Such systems so described are limited in that although they are able to monitor the administration of medicines they are unable to control the actual use of the medication by locking or unlocking as a result of the information that they have monitored. Several systems have been described which can be locked and unlocked to control the dispensing of medication.

GB2368061 discloses a dispensing system with a mechanical actuation mechanism which when activated allows a measured dose of material to be dispensed. A locking mechanism prevents the mechanical actuation mechanism from dispensing a dose of material until it is released in accordance with a dispensing programme. Once the mechanical actuation mechanism has been unlocked and a dose has been dispensed it can be re-locked against further dispensing. Unlocking can be effected by either remote control or by the exchange of signals between the dispenser and a base station. The method by which the dispensing system operates to allow the secure delivery of material from the dispenser is not detailed; purely the mechanical operation of the dispenser is disclosed.

WO 2003/070304 describes a dispensing device with a patient diary. The dispensing system, described in the application GB2368061, is provided with a user interface, which allows data to be inputted by a user, which can then be sent to a control device, which is remote from the dispenser. The control device can then carry out specific functions relating to the control of the dispenser including the release of the locking system and updating of the dispensing regime. This feature allows the operation of the dispensing device to be monitored and updated or revised as necessary throughout the course of its use.

WO 2003/070304 also describes the use of the dispensing system with a cartridge, which may be programmed to contain data that is specific to the user. Once the cartridge has been inserted into the dispenser it can be used to control the operations of the device.

WO 2003/070304 also describes the use of the dispensing system with a feature that is able to monitor the location of the dispensing mechanism and only allow the dispensing of material from the dispenser if it is within a specified location. It does not however go on to describe detailed methodology of how such features operate.

WO 2005/004961 describes a dispenser with a reservoir, which is designed to contain a plurality of dosage units for drugs of abuse. The dosage units are contained in a tamper evident manner so that access to the drug of abuse can be controlled either by the dispenser or remotely. The way in which the dispenser is used can also be monitored again either by the dispenser or remotely. The methodology and system whereby the dispenser is controlled and monitored is not however disclosed.

GB2417116 discloses a dispensing system that has a locking mechanism to prevent the material contained within the dispenser from being dispensed without authorisation. The control of the device allows a user to authenticate themself by one or more biometric means of identification. The application also describes the use of a secure key, which allows a user (which may be someone other than the patient, for example, the pharmacist) to access restricted functions of the dispensing system. Control of the key is also achieved by the biometric authentication of the user.

The present application discloses a system which enables the monitoring, tracking and recording of data associated with the product and the points along a pathway.

The term “influence” or “influencing” refers to a direct or indirect effect upon a product.

The term “movement” refers to the transfer of a product from one point in a pathway to another.

The term “product” refers to an object or other entity, and includes without limitation a drug, a person or data.

The term “point” or “points” refers to the positions, locations or steps that the product has or will encounter in the flow of the product through a pathway.

The term “pathway” refers to a course through which the product moves and includes without limitation a pharmaceutical supply chain.

The term “data” refers to an element or collection of elements of information and may include a signal.

The term “signal” refers to an asynchronous event that is transmitted between two points.

The term “information repositories” refers to a store of data capable of receiving, communicating or managing data. It also includes sending and manipulating data.

The term “hub” refers to a means of manipulating, hosting, transmitting or receiving data and includes without limitation: a data router, an application host, a firewall, a service centre or a communications gateway.

The term a “point-product interface” refers to an apparatus that interfaces with the product and the point.

The term “communicate” or “communicating” refers to one or more of the following functions: receiving data, sending data, interpreting data, processing data or acting upon data.

The term “real-time” refers to the communication of data so rapid that the interaction appears to be instantaneous or near instantaneous.

The term “product handler” refers to an intermediate in the pathway between points to which the product is moved.

The term “user” refers to an object, person, or a part of the system or another system, which may require access to the products, points or the data.

The term “manipulate” refers to the changing, packaging, splitting, compressing, amending, copying or repackaging of one or more of the following: the data, the product or the point.

### SUMMARY OF THE INVENTION

According to the first aspect of the present invention there is provided a system for:
influencing the movement of one or more products between points along a pathway; and
managing data associated with the one or more products and their movement between the points;
   comprising:
one or more information repositories;
one or more hubs allowing access to and from the information repositories; and
at least one point-product interface for communicating data to and from the information repositories;
   wherein the point-product interface:
operates in real-time; and
influences movement of the one or more products between points along the pathway by communicating data associated with at least:
   the products; and
   the points;
      and after communicating with the one or more information repositories is able to authorise movement of the one or more products to the next point.

The system herein described is able to influence and manage the movement of a product between different points in the pathway by utilising apparatus such as the point-product interface. This apparatus is able to operate in real-time, which means that once it has communicated data to and from the information repositories it can then communicate with either the product or the point. This communication is vital in influencing the movement of the product as the communication that is sent is then able to authorise the products movement.

The invention herein described is clearly able to communicate with the information repository, the product and the point. It also has the ability to communicate with more than one of the items in order to authorise the movement. This might be useful in some cases where there is a high level of security required, for example if the product is a drug which is a controlled substance such as diamorphine. The tallying of authorisation by the information repository and the product and the point would mean that there was the highest level of security as possible and there would be no opportunity for the system to be corrupted.

Optionally the point-product interface is able to authorise movement of the one or more products to the next point after further communicating with a product handler.

Optionally the point-product interface additionally allows an authorised user access to particular data from the system.

Alternatively movement may be authorised based on data or external interation.

The user is an object, person, or a part of the system or another system, which may require access to the products, points or the data. This could be for example a computer system operated by a pharmaceutical company. As the point-product interface of the invention is able to communicate with this computer system it means that the pharmaceutical company is able to directly access data related to (for example) a trial that it is running with the company who are operating the system of the invention.

Preferably the point-product interface additionally manipulates the data.

This is advantageous to the system of the invention as it means that the data communicated from either the information repository, the product or the point (or a combination of the above) can be altered in some manner. For example, this means that the data can be amended to change the authorisation of the movement of the product or it can be repackaged to mean that it can be read by a different piece of equipment.

Preferably the point-product interface additionally manipulates the product.

This is of real value to the system of the invention as it means that the product can be changed in order to fulfil the requirements of the system. For example, if the product is a drug delivery device then the point-product interface is able to manipulate the device in order to either unlock or lock the device against dispensing. This could be as a result of communicating with the information repositories and receiving a communication to not authorise the drug stored within the device to be dispensed.

Preferably the point-product interface additionally manipulates the point. This is also of use to the system as it means that the point itself can be altered in some manner to satisfy the communications received from the information repository, the product or the point.

An example of such a point that requires manipulation could be when the point is a dispensing location. The point-product interface could manipulate the dispensing location to enable it to either dispense or lock it out from further dispensing.

The point-product interface may be associated with either the product or the point. This may entail the product or the point being manufactured to contain the point-product interface within it. Alternatively it may be that the point-product interface is able to reversibly attach to the point or the product.

Preferably the point-product interface after communicating with the one or more information repositories forbids and locks or otherwise disables the one or more products preventing movement.

The ability of the system of the invention in addition to authorising the products movement to the next point to actually forbid its movement means that the system is useful in the control of secure substances such as controlled drugs. For example if the product is a controlled drug such as diamorphine the capability of the system to forbid the drugs movement means that the security of the product is maintained at all times throughout its supply chain.

Preferably the one or more products is a drug and the points are steps associated with movement of the drug along a supply chain.

In a second aspect of the present invention there is provided a method for influencing in real-time the movement of one or more products along a pathway and managing data associated with the one or more products and their movement between the points comprising the steps of:
obtaining data associated with the one or more products and the points;
communicating data through one or more hubs to one or more information repositories;
analysing the data communicated to the one or more information repositories;
communicating the data back to the one or more products or points; and
authorising or forbidding the one or products to be moved to the next point.

Preferably the one or more products is a drug and the points are steps associated with movement of the drug along a supply chain.

In one embodiment of the invention one point along the pathway is a place of drug manufacture and another point along the pathway is a warehouse.

In a further embodiment of the invention one point along the pathway is a doctor and another point along the pathway is a patient.

Preferably a further point along the pathway is a pharmacy.

Preferably a still further point along the pathway is a drug dispensing device.

Optionally the method further comprises a step which additionally allows an authorised user access to particular data from the system.

Preferably the authorised user is selected from the following: pharmaceutical company; healthcare providers; government bodies; institutions.

There are many relevant users of the system described by the present invention these include but are not limited to; the Home Office; the Department of Education; the Treasury; the Department of Health; the Strategic Health Authority; the National Treatment Agency; the National Dug Strategy Directorate; The National Drug Treatment Monitoring Service; Regional Managers; Primary Care Trusts; Voluntary Services; Acute Trusts; Pharmacists; Community Nurses; General Practitioners; Hospitals; Drug Addiction Services; Police; Probation Services; Prisons; Criminal Justice; Prescription Pricing Authority; Drug Alcohol Reference Group; Crime and Disorder Reduction Partnership; Drug Alcohol Action Teams; Drug Alcohol Action Team Boards; County Councils; Social Services; Drug Prevention and Advisory Services; Government Office Drug Teams; Strategic Co-ordination and Planning groups; Community and Law Enforcement and Organised Crime and National Groups.

Preferably the patient is one of the following: a patient requiring treatment for drug addiction; an elderly or otherwise infirm patient; a child; a patient being treated as part of a clinical trial; a patient being treated in a controlled environment. Preferably the controlled environment is a hospital.

The system described in the invention is of use in the treatment of the patients detailed above. In particular the system provides the ability to send an alert to a patients carer or doctor. The form that this alert can take could be for example a text message sent to the carer's mobile phone.

In a third aspect to the present invention there is provided a method of allowing an authorised user to access data associated with the movement of one or more products along a pathway comprising the steps of:
storing data associated with the movement of the one or more products in one or more information repositories;
obtaining data associated with the user;
communicating the data associated with the user through one or more hubs to the one or more information repositories;
analysing the data associated with the user communicated to the one or more information repositories;
authorising or forbidding the user to access the data; and
communicating authorised data back to the user.

Certain aspects of this invention are further described, by way of example only, with reference to the accompanying drawings in which:

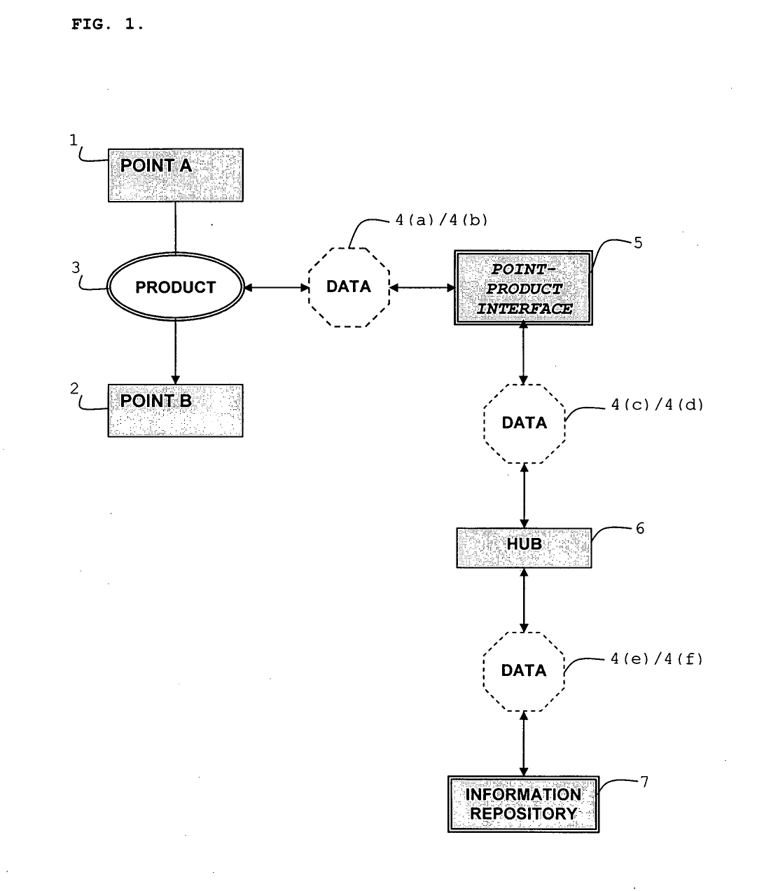

FIG. 1 shows a flowchart detailing the movement of a product from one point to another along a pathway;

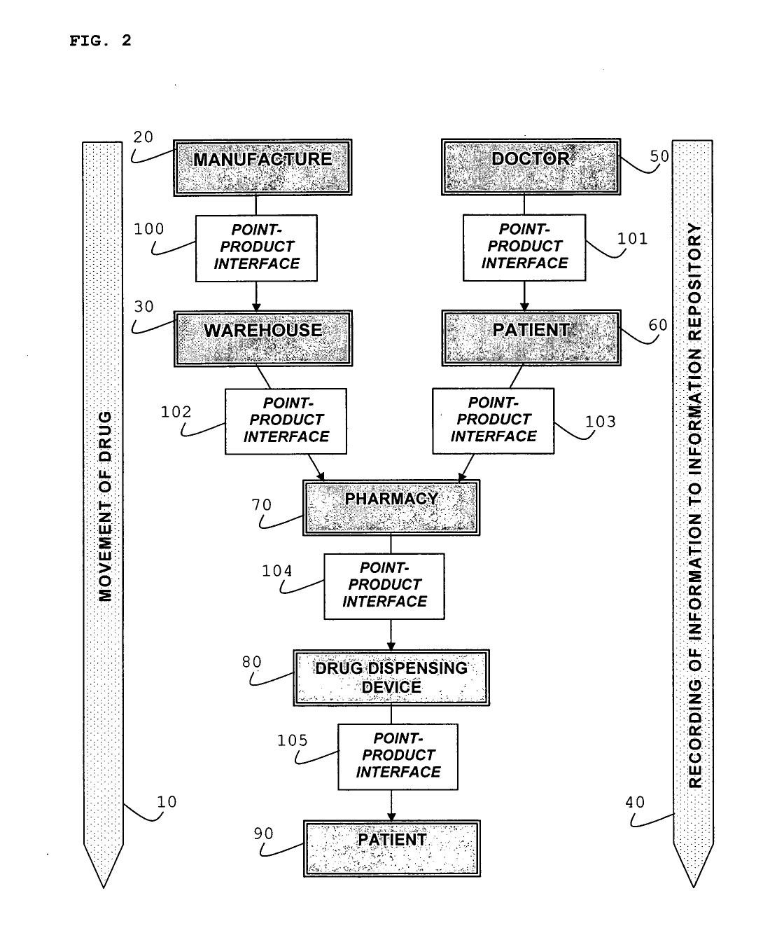

FIG. 2 shows an exemplification of how the system operates when a product, such as a drug, is moved through a supply chain pathway;

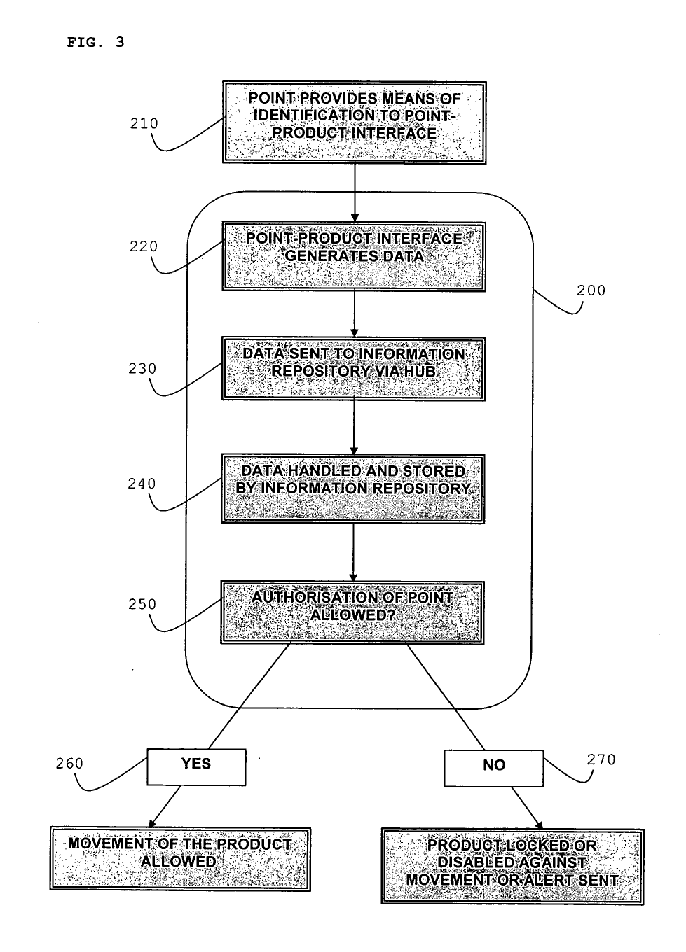

FIG. 3 shows expanded details of how the point-product interface operates; and

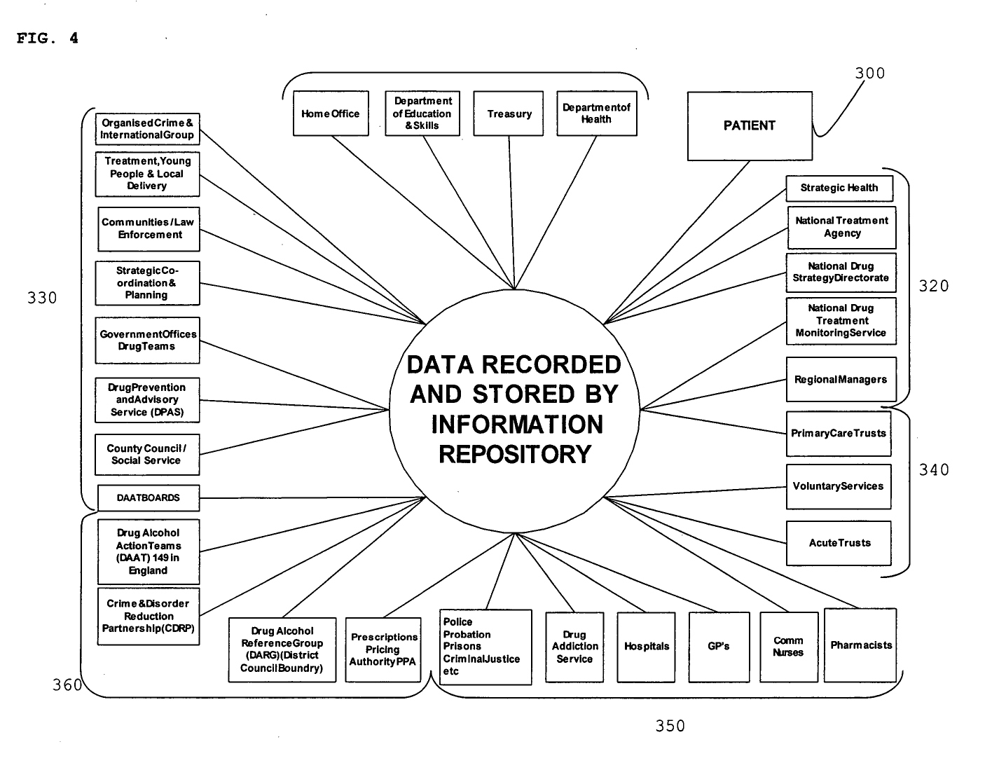

FIG. 4 describes in expanded detail an exemplification of how different users may access data relating to the movement of a product.

### SPECIFIC DESCRIPTION

As previously discussed the present invention relates to a system for influencing and monitoring the movement of products between points along a pathway. The system can also be programmed to provide different levels of control at different points of the supply chain. The invention utilises a point-product interface to authenticate a point prior to authorisation of the movement of the product. Such means can take the form of an apparatus that are able to read and write data to another piece of apparatus or an information repository. In such a manner an authorisation is obtained at each step in the pathway and the data obtained from the authorisation is stored centrally and can be accessed by other points once authorisation is obtained.

Turning to FIG. 1 there is detailed a flowchart that illustrates the movement of a product [3] between two points [1 and 2]. The system of the invention is able to influence and monitor the movement of the product [3] between point A [1] and point B [2] by the use of a point-product interface [5]. The point-product interface [5] works by communicating data [4(a) to 4(f)] to and from an information repository [7].

The data [4(a)] relating to the product [3] is communicated to the point-product interface [5], which may then manipulate the data in some manner prior to communicating the data [4(c)] via a hub [6] to the information repository [7]. The hub can take the form of any means of manipulating, hosting, transmitting or receiving data, for example, a data router.

The hub [6] then communicates the data [4(e)] to the information repository [7]. The information repository [7] is a store that can firstly receive and manage the data. For example it may compare the data received [4(e)] with the data stored in the information repository [7] and determine from the data whether the product [3] is authorised for movement to point B [2].

Once the information repository [7] has managed the data it then communicates data [4(f)] back to the product [3].

The way in which this is achieved is by communicating the data [4(f)] firstly to a hub [6] which will route the data [4(d)] back to the or another point-product interface [5]. The point-product interface [5] may then additionally manipulate the data before communicating the data [4(b)] to the product [3] and/or a user.

If the data [4(b)] received by the product is an authorisation for the product to be moved from point A [1] to point B [2] the movement may occur.

If the data [4(b)] received by the product is a communication forbidding the movement of the product [3] from point A [1] to point B [2] then movement will be prevented, for example, by the product [3] being locked or disabled or in some manner its movement prevented.

An example of how the system of the invention may operate in practice is described in FIG. 2. The different points of a supply chain are represented and the movement of the product through it is represented by an arrow [10]. In the example described the product is a drug.

The first point in the pathway is the place of manufacture [20]. Many drugs are produced and packaged in a form suitable for transfer as opposed to immediate dispensing. Alternatively, pharmaceuticals are packed together in batches ready for transport to a warehouse where they will await dispatch to a dispensing location.

The invention herein described allows for the controlled movement of the product from the protected environment of the site of manufacture to a subsequent point—the warehouse [30]. This is achieved by imposing a step [100] in the pathway that requires the product, the point or optionally the product handler to receive authorisation by the system before movement can occur.

One example of the way in which movement can be influenced is through packaging the bulk samples in a locked container which is provided with a point-product interface such as a barcode reader, a biometric sample reader, such as a fingerprint reader, an RF tag reader or a simple means such as a keypad into which a user may type in an identification number.

In FIG. 2 this means of authorisation is denoted by the point-product interface [100-105], which intercepts the products pathway.

At each step of the products pathway through the supply chain, when the movement of the product is authorised, a record is sent to the information repository, as denoted by arrow [40]. The means whereby the data is communicated can be via existing telecommunication networks such as the GSM network or via other means.

In the same manner whereby data is sent to the information repository to record that the product has been authorised to move from one point to another point, data may also be communicated to another point, product or product handler to convey that the product has been moved or that the product has been safely received.

Once the drug has been received by the warehouse [30] it is once again received into a secure environment. At this stage the drug is stored awaiting onward transport.

The authorisation procedure for the movement of the product can again be put in place when shipping the stocked drugs from storage in the warehouse to the place of dispensing such as a pharmacy [70]. A similar authorisation procedure can be used as described in the section above [100] as occurs here [102]. For example a bulk package can be secured inside a locked container that can only be opened by an authorised individual.

Also described in FIG. 2 is a second branch of the supply chain pathway within which it is also imperative to provide influence and monitoring. Generally a doctor [50] will examine a patient [60] and prescribe a medication or pharmaceutical product to him.

The exemplifications provided in the present application are focused to the situation in the United Kingdom. It should however be noted that although in different countries the pathways involved in the movement of (for example) a drug to a patient will differ the basic procedure described by the present application will be the same. That being the influencing and monitoring of a product along a pathway.

In recent years it has become increasingly important to also monitor the prescribing behaviour of doctors. The Shipman Enquiry has also recommended that a full audit trail be kept, in particular when the prescribed drugs are controlled drugs. At the time of writing there are no measures in place which are able to monitor in real-time the way in which a doctor prescribes medications. The present invention is therefore of tremendous value in this field alone.

One example of the way in which this system could work would be to provide a database of all medical practitioners who have the authority to prescribe medicaments.

When a patient visits his doctor and the doctor prescribes a certain medication for that patient he would have to obtain authorisation by the system of the invention prior to a prescription being produced. One way in which this could be achieved could be through the doctor's being provided with point-product interface that would enable the doctor's identity to be authorised [101].

For example the doctor's computer or workstation may incorporate the point-product interface.

The authorisation means could be as simple as via an identification number inputted by the doctor or the reading of a barcode or magnetic strip on a card. It could also be more complex and therefore more secure by utilising means such a reading an RF tag or more complex still by way of reading a biometric measure provided by the doctor such as a fingerprint scan.

The data provided by the doctor to authorise himself is communicated in real-time to an information repository and verified. If the doctor is sanctioned to prescribe the medication that he has asked for the prescription will then be created and can be passed onto the patient.

The advantage of such a system is immediately obvious in that firstly only doctors authorised to prescribe certain medications will be able to actually produce a prescription. A second advantage of the invention is that even if a doctor is authorised to prescribe medications such as controlled drugs his prescribing behaviour can be monitored in real-time. If anomalies in the doctor's prescribing behaviour are observed then the authorisation can be removed or cancelled.

The system therefore has the potential to influence the movement of a product even before the prescription is printed.

Systems such as those described above would have enabled the over-prescribing of controlled drugs by Harold Shipman to be spotted and eliminated at a far earlier stage if not removed all together.

Once the patient [60] has received the prescription from his doctor he will need to go to a dispensing pharmacist [70] in order to have his prescription filled. By building in a step that requires the authorisation of the patient at this stage the patient can also be monitored. At the present time there are no means to identify a patient arriving at a pharmacy to have his prescription filled, other than the provision of his signature.

The use of the system described in the present invention will enable an assurance that the patient presenting with the prescription is the patient that has been prescribed the medication. One example in how this authorisation can be achieved is by providing the pharmacist with point-product interface for checking the patient's identity and authenticity [103]. Such apparatus can be provided as part of the pharmacies workstation or computer. The patient's name can be inputted into the system and checked against an authorised list, which would have been automatically updated when the doctor prescribed the medication to the patient.

The identity of the patient can be further checked by means such as reading a biometric measure for instance a fingerprint of the patient that has previously been stored in the database.

The pharmacy [70] is an important step in the supply chain pathway as it is the amalgamation of the branches from the manufacturing/supply pathway and the doctor/patient pathway.

It is envisaged as part of the invention that the pharmacist will be authorised as a fundamental user of the system. One exemplification of how the invention may be put into place at this stage of the supply chain is through providing the pharmacist with a means of authorising himself in order to both take delivery of the pharmaceutical products and also to dispense the pharmaceutical products.

One example of such authentication means is a secure key, which can be inserted into a lock to allow the pharmacist access. The secure key is produced to comprise a means of identifying the pharmacist. Further details of such a secure key are detailed in the applicants United Kingdom patent application GB0417793.7 (unpublished).

As previously described the drugs could be delivered to a pharmacy in a locked storage container to which access is only provided once the user has been authorised. Once the pharmacist receives the prescription from a patient [60] and the patient has been authenticated [103] the pharmacist will wish to dispense the patient's medication.

The pharmacist will authorise himself [104] to a drug dispensing device [80] via his point-product interface as described in the previous paragraphs. By doing so he will also prime the drug dispensing device to be used only by the authorised patient. Examples of such devices can be found in the applicant's International patent application WO 2003/070304 and United Kingdom patent applications GB2368061 and GB0417793.7 (unpublished). The drug is enclosed within the dispensing device, which is locked against dispensing. The pharmacist is also able at this stage to programme the dosing instructions provided by the doctor's prescription into the device.

Once this procedure has been completed the drug dispensing device [80] containing the drug can be supplied to the patient. The drug dispensing device may incorporate the point-process interface as part of the device.

Although this point appears to be fairly lengthy it is envisaged that because the system operates in real-time the entire time taken for the movement of drug from the site of manufacture to the patient and simultaneously from the doctor prescribing the medicine to a patient to him being provided his drugs will only require a small amount of extra time. Once the system is in place the actual authorisation point will take only a matter of seconds.

The patient [90] is then able to leave the pharmacy [70] with his medication contained within his drug dispensing device. The device which has been programmed by the pharmacist will allow the patient to access his medication at the pre-programmed intervals. At such a point when the patient is due to take his medication he will require authorisation [105] before he can dispense a dose of drug from the device.

This can be, for example, by providing the drug dispensing device with a means to identify the user, for example, reading a fingerprint. By using such a system the drugs movement can be influenced and monitored and the movement of the drug can be maintained throughout the patient's dosage regime. This holds particular advantages over the current scheme particularly when a controlled drug or pharmaceutical has been prescribed.

The flowchart detailed in FIG. 3 provides expanded details of how the authorisation procedure at a certain point in the supply chain pathway operates. The point-product interface [200] can be used at any stage of the supply chain pathway as previously described and detailed in FIG. 2.

In the example described in FIG. 3 it is envisaged that the point is a patient and the product is a drug.

In the first stage, denoted [210] in the flowchart the point, in this case a patient, offers his means of identification to the point-product interface [200]. Such means of identification can include but are not limited to personal identification (PIN) numbers, barcodes, magnetic strips, RF tags or biometric samples.

Biometric samples include but are not limited to fingerprints, retinal scans, DNA, facial characteristics, voice recognition, handwriting recognition or palm prints.

Once the point-product interface in stage [210] has read the means of identification provided by the point, data is generated [220] which can optionally be manipulated by the point-product interface.

The next stage of the pathway involves the data created in stage [220] being communicated to an information repository [230]. The ways in which this data can be communicated are numerous and are well known in the art. The invention is exemplified by the sending of the data via a telecommunications network such as the GSM network.

The data that has been communicated to an information repository as described in stage [230] is compared or in some manner manipulated by the information repository in stage [240] in order to determine whether the identification information provided by the point matches with the records currently stored and also whether the point has the authorisation to undertake the procedure that has been requested.

For example, if the point is a doctor and the data sent to the information repository is that the doctor wishes to prescribe a controlled drug such as diamorphine to a certain patient, the information repository will be required to obtain and manage data on three aspects.

Firstly the information repository will check that the identification information provided by the doctor matches with the record for the doctor stored on the information repository.

If this identification check is valid then the information repository will further manage the data in order to determine whether the doctor is authorised to prescribe the controlled drug diamorphine.

If this is authorised, then the last stage will be to determine whether the named patient is authorised to be prescribed the drug.

In the next stage of the flowchart, following the pointing of the data by the information repository, it is necessary to communicate the data processed by the information repository back to the point to enable authorisation or prohibition of the movement of the product [250].

In the case that the point fulfils the authorisation procedure data will be communicated back to the point-product interface to allow movement of the product [260]. In the case of the point not fulfilling the authorisation requirements, the product may be locked against further movement [270].

In the case of a doctor prescribing diamorphine to a patient the required movement of the product would be to produce a prescription. If the point is not authenticated then the system of the invention would not allow a prescription to be produced.

In this case the data would also be stored in the information repository and depending on the importance or severity of the failure to achieve authorisation an alert message could be sent to a person responsible for monitoring that particular part of the system.

FIG. 4 describes in expanded detail an exemplification of how different users may access data relating to the movement of a product. In this example the point [300] is a patient that is requiring treatment for drug addiction, to a controlled drug, for example heroin. Very often the treatment provided to such an individual would be through the provision of methadone. The drug dispensing device described in the applicants United Kingdom patent application GB0417793.7 (unpublished) could be programmed to allow the patient to access his dose twice daily. It could also be programmed to allow the dosage to be gradually reduced thereby allowing a patient to be progressively weaned off the addictive substance.

FIG. 4 shows in great detail how the information that is produced when the patient uses his drug dispensing device (and as such his medication) can be used by different groups. The data that is produced by the patient using his medication is communicated to and stored by the information repository.

The data regarding how the patient uses his medication could include information concerning how many doses of the medication the patient has used and whether the patient has tried to take more doses of the medication or if any alerts have been triggered by an unauthorised individual attempting to use the apparatus.

Such information is of tremendous value to bodies such as Government Departments [310], Government implemented drug groups [320] and [330], NHS trusts [340], healthcare providers [350] and other groups [360].

The data can be used by such bodies to provide definitive information on all aspects of the supply chain including a doctors prescribing practice, the effectiveness of the treatment, the numbers of patients being treated by a certain medication, the frequency and dosage of the medicine and the costs of providing the medication. This in turn will enable a far more effective and successful treatment programme for the patient and is also likely to lead to cost reduction in practice.

The advantage of such a system is that groups, such as the Drug Prevention Advisory Service or individuals such as a GP can be provided with point-product interface enabling authorised access to given data.

It is immediately obviously by looking at the scheme provided in FIG. 4 that such a system can be applied to areas other than the treatment of drug addicts.

The system can also be applied is in the area of clinical trials.

When a pharmaceutical company sets up a clinical trial in order to test the safety and efficacy of a new pharmaceutical product it is beneficial to garner as much information about the effectiveness and use of the product as possible. The use of the scheme described in FIG. 4 would allow the company sponsoring the trial to monitor in real-time the way in which the drug is being taken.

The system would also be of use in a clinical trial situation as it would enable the drug to be taken at pre-programmed and recorded times ensuring that when samples such as blood tests are taken from a patient the resulting information can be plotted very accurately on a time scale. The fact that data can be collected and processed in real-time is clearly of benefit.

Patient compliance is also another area in which the system for influencing and monitoring the movement of products is advantageous. The system described by FIG. 4 can be used to monitor how a patient is using their medication. Bespoke drug regimes can be implemented if a patient is being monitored and it is determined that the patient requires, for example, a stronger dose of medication than that which is currently being provided. Monitoring in such a way would also be able to prevent patients from overdosing from their medicines by only allowing a patient to access their medication according to a pre-programmed regime.

The system described by this invention is also of use in the prevention of drug diversion and misuse. It is a commonly known problem that drugs, in particular, controlled drugs such as narcotics and benzodiazepines can be diverted from the patient to whom they are prescribed onto the black market. The use of the system described in the invention would ensure that even if a drug was diverted onto the black market the system could alert the necessary authorities and monitor the attempted use of the product. This could for example take the form of recording a fingerprint of an unauthorised user so that person attempting to misuse the product can be apprehended more quickly.

Another useful application of the system of the invention is in a controlled environment such as hospitals, clinics or nursing homes. Here the immediate use of the invention would ensure that the correct medication was provided to the correct patient. The use of the system would enable a closed loop audit trail. By this it is envisaged that an enhanced safety system would be in place in such controlled environments whereby the product could be tracked and managed throughout the system. For example when a patient is in hospital his drugs will be requisitioned from the hospital pharmacy. Written records must be kept by the pharmacy for all controlled drugs and this is both time consuming and could lead to mistakes or problems occurring.

The way in which the invention herein described functions would mean that a secure record would be kept and logged each time an authorisation procedure took place. In so doing this would ensure that a product such as a drug could be tracked and managed from the pharmacy to the patient and even out of the controlled environment of the hospital to the patient's own home when he is discharged.

The advantages of such a system in a controlled environment are numerous. These include for example, inventory management whereby once drugs were used or dispensed from the hospital pharmacy this would be recorded and logged and as such an automatic re-order could be placed with the suppliers once stocks reached a critical level. Other uses of the invention in this field could include the automatic billing of patients for their medications due to the records being kept securely and updated in real-time.

At the present time there is not currently a useful system in place whereby the elderly and their use of medications can be monitored. For example, if an elderly person forgets to take their medication there are no means in place to remind them they should take their medicine. This is a very important area in which the invention described herein is able to provide means within which an elderly person's medication can be monitored.

In the following exemplification it is envisaged that an elderly patient has been prescribed a medication for the treatment of their medical condition. Very often medications must be taken several times daily in order to have an effect and as such if a patient does not take their medicament they may become ill or their condition may worsen.

As the system of the invention herein described is able to influence and monitor in real-time when the drug dispensing device is authorised and therefore when the drug stored within it has been administered it can be programmed to send an alert either to the patient themselves or to the patient's family or carer to remind them to take the medication if they are late in taking it.

Such a system would also be of use to the elderly patient's doctor as under the current system if a drug does not appear to be efficacious to a patient then the doctor will often prescribe a different drug. In many cases the reason why the drug is not efficacious is because the patient often forgets to take their medication.

The invention described herein would enable a doctor to look at the data produced for the patient and their administration of their medication and as such be clearer as to whether it was the drug that wasn't working or that the patient had not taken their medication as they should have.

The invention could also clearly be used in the case where the patient is a child or is otherwise unable to keep track of their medication usage themselves.

Other uses of the system of the invention include its use in the general population. For example the system could provide a simple and effective way of alerting in the case of a product recall or expiry date lapsing. It would also provide useful means within which to study the general use of drugs in a population.

The way in which the system of the invention could alert a user of the system are numerous. Examples of the types of alert include but are not limited to; text messaging to a mobile phone; text messaging to a landline; sending a recorded message via the telephone system; sending an electronic mail and displaying the message on a persons drug dispensing device.

Any numbers incorporated into the claims are included to enhance the clarity of their reading. They are to be construed as non-limiting to the features of the invention herein described.

1. A system for:
influencing the movement of one or more products [3] between points [1, 2] along a pathway; and
managing data [4(a)-(f)] associated with the one or more products [3] and their movement between the points [1,2];
comprising:
one or more information repositories [7];
one or more hubs [6] allowing access to and from the information repositories; and
at least one point-product interface [5] for communicating data [4(a)-(f)] to and from the information repositories [7];
wherein the point-product interface [5]:
operates in real-time; and
influences movement of the one or more products [3] between points [1,2] along the pathway by communicating data [4(a)-(f)] associated with at least:
the products [3]; and
the points [1,2];
and after communicating with the one or more information repositories [7] is able to authorise movement of the one or more products [3] to the next point [2].

2. A system as claimed in claim 1, wherein the point-product interface [5] is able to authorise movement of the one or more products [3] to the next point [2] after further communicating with a product handler.

3. A system as claimed in claim 1, wherein the point-product interface [5] additionally allows an authorised user access to particular data from the system.

4. A system as claimed in claim 1, wherein the point-product interface [5] additionally manipulates the data [4(a)-(f)].

5. A system as claimed in claim 1, wherein the point-product interface [5] additionally manipulates the one or more products [3].

6. A system as claimed in claim 1, wherein the point-product interface [5] additionally manipulates the point [1,2].

7. A system as claimed in claim 1, wherein the point-product interface [5] after communicating with the one or more information repositories [7] forbids and locks or otherwise disables the one or more products [3] preventing movement.

8. A system as claimed in claim 1, wherein the one or more products [3] is a drug and the points [1,2] are steps associated with movement of the drug along a supply chain.

9. A method for influencing in real-time the movement of one or more products [3] along a pathway and managing data [4(a)-(f)] associated with the one or more products [3] and their movement between the points [1,2] comprising the steps of:
obtaining data [4(a)] associated with the one or more products [3] and the points [1,2];
communicating data [4(c)] through one or more hubs [6] to one or more information repositories [7];
analysing the data [4(e)] communicated to the one or more information repositories [7];
communicating the data [4(b),(d),(f)] back to the one or more products [3] or points [1,2]; and
authorising or forbidding the one or products [3] to be moved to the next point [2].

10. A method as claimed in claim 9, wherein the one or more products [3] is a drug and the points [1,2] are steps associated with movement of the drug along a supply chain.

11. A method as claimed in claim 9, wherein one point along the pathway is a place of drug manufacture [20] and another point along the pathway is a warehouse [30].

12. A method as claimed in claim 9, wherein one point along the pathway is a doctor [50] and another point along the pathway is a patient [60].

13. A method as claimed in claim 9, wherein one point along the pathway is a place of drug manufacture [20], another point along the pathway is a warehouse [30] and a further point along the pathway is a pharmacy [70].

14. A method as claimed in claim 9, wherein one point along the pathway is a doctor [50], another point along the pathway is a patient [60] and a further point along the pathway is a pharmacy [70].

15. A method as claimed in claim 9, wherein one point along the pathway is a place of drug manufacture [20], another point along the pathway is a warehouse [30], a further point along the pathway is a pharmacy [70] and a still further point along the pathway is a drug dispensing device [80].

16. A method as claimed in claim 9, wherein one point along the pathway is a doctor [50], another point along the pathway is a patient [60], a further point along the pathway is a pharmacy [70] and a still further point along the pathway is a drug dispensing device [80].

17. A method as claimed in claim 9, wherein the method further comprises a step which additionally allows an authorised user access to particular data from the system.

18. A method as claimed in claim 17, wherein the authorised user is selected from the following:
pharmaceutical company; healthcare providers; government bodies; institutions.

19. A method as claimed in claim 12, wherein the patient [60,90] is a patient requiring treatment for drug addiction.

20. A method as claimed in claim 12, wherein the patient [60,90] is an elderly or otherwise infirm patient.

21. A method as claimed in claim 12, wherein the patient [60,90] is a child.

22. A method as claimed in claim 12, wherein the patient [60,90] is a patient being treated as part of a clinical trial.

23. A method as claimed in claim 12, wherein the patient [60,90] is a patient being treated in a hospital.

24. A method of allowing an authorised user to access data [4(a)-(f)] associated with the movement of one or more products [3] along a pathway comprising the steps of:
storing data [4(a)-(f)] associated with the movement of the one or more products [3] in one or more information repository [7];
obtaining data associated with the user;
communicating the data associated with the user through one or more hubs [6] to the one or more information repositories [7];
analysing the data associated with the user communicated to the one or more information repositories [7]; authorising or forbidding the user to access the data; and
communicating authorised data back to the user.
